(19) United States
(12) Patent Application Publication
(10) Pub. No.: US 2017/0268138 A1
(43) Pub. Date: Sep. 21, 2017

(54) Trilobal Waterproof Breathable Laminated Stretch Fabric

(71) Applicant: Alliance Mercantile Inc., Burnaby (CA)

(72) Inventors: Douglas BELL, North Vancouver (CA); Darren TEES, Calgary (CA); Wu Hai HAO, Beijing (CN)

(21) Appl. No.: 15/612,741

(22) Filed: Jun. 2, 2017

Related U.S. Application Data
(63) Continuation-in-part of application No. 14/287,150, filed on May 26, 2014, now abandoned.
(60) Provisional application No. 61/827,068, filed on May 24, 2013.

(51) Int. Cl. D03D 15/08; B32B 27/12; B32B 27/40; B32B 5/02

(52) U.S. Cl. CPC D03D 15/08; B32B 5/024; B32B 27/12; B32B 27/40; B32B 2262/0276; B32B 2307/51; B32B 2437/00; B32B 2307/304

(57) ABSTRACT

A woven polyester fabric with a trilobal construction and a 5% elastane content, and an outer laminated layer of polyurethane, with 250 GSM insulation. The fabric and clothing made from the fabric is waterproof, breathable, stretchable in 4 directions, and insulating to −50 degrees Celsius. The fabric meets the standards defined by the testing standards ASTM D2034-2009; ASTM D1424-2009: ASTM D434-1995; ASTM D4970/D4970M-2010c1, ASTM D3107-07(R2011), AATCC 127, and JIS L1099 Method B-1:2006.

### FIELD OF THE INVENTION

The present invention relates to industrial fabrics. In particular, the present invention relates to a multi-function fabric for use in a variety of clothing and other items for use in adverse conditions.

### BACKGROUND OF THE INVENTION

Industrial and recreational waterproof outerwear, and waterproof/breathable outerwear for the industrial market, are well known in the prior art. Industrial outerwear producers focus on the durability, tensile strength, puncture and tear resistance of fabrics to ensure that the garments will not fall apart while being worn in their intended fields of use, including forestry, lumber yards, construction, mines, oil rigs, and other areas. In producing waterproof or waterproof/breathable outerwear, most garments are made with polymer based fibers or laminates such as nylon, polyester, polyvinyl chloride (PVC), and polyurethane (PU). PVC and PU are generally used as a solid laminate on a supporting fabric, whereas nylons and polyesters are threads which are woven into a fabric, then either laminated or spray coated with a water sealing film of PVC or PU.

Industrial strength garments require high tensile and tear strengths. The physical properties of nylon and polyester vary considerably, with nylon being significantly stronger than polyester. However, nylon is a very porous filament and as such does not hold color dyes very well; whereas polyester holds bright color dyes extremely well.

The strength of a fiber will depend on the thickness of the fiber (the “denier” of the thread); the thicker the thread fiber, the higher the tensile strength and heat resistance of the final fabric. However, as the denier of the fabric is increased, flexibility in the fabric is reduced. The resulting fabric will be harder, heavier, and stiffer.

As least until 2008 most industrial waterproof and waterproof/breathable garments were made from high denier nylon of approximately 420 Denier or from thick laminates of PVC or PU with supporting back fabrics. These garments were heavy and inflexible, but highly durable and were produced in colors of yellow, black, green and orange.

In 2008 there was a market change brought about by the safety industry to introduce more high visibility fabrics into the industrial market—colors of Hi Vis such as green, yellow and orange. These colors used bright dyes that needed to be “set” into the fabrics as they required durability and reflectivity retention after 50 washes. Nylon's, PVC, and PU polymers have poor dye retention, and the introduction of these high color dyes created industry problems with dye running from the fabrics, turning the consumers' skin or other clothing orange or green. As such, the industry started to move toward use of polyester as polyester had a much higher ability to “set” bright color dyes. Unfortunately, polyester fabrics are considerably weaker in tensile, tear and puncture resistance, the result being that the garments would not stand up to the rigors of the intended application.

It would be desirable to provide a polyester-based fabric which has high tensile, tear and puncture resistance, while maintaining its dye-retention properties.

### BRIEF DESCRIPTION OF THE DRAWINGS

A detailed description of the preferred embodiment is provided by way of example only and with reference to the following drawing, in which:

FIG. 1 is an exploded view of the fabric of the invention, depicting the trilobal construction checkerboard pattern, according to the invention.

In the drawing, one embodiment of the invention is illustrated by way of example. It is to be expressly understood that the description and drawing are only for illustrative purposes and as an aid to understanding, and other embodiments are also within the scope of the invention.

### SUMMARY OF THE INVENTION

There is provided a woven polyester fabric having a trilobal woven construction and a 5% elastane content. The fabric may have an outer laminated layer of polyurethane, and 250 GSM insulation. The fabric meets the standards defined by the testing standards ASTM D2034-2009; ASTM D1424-2009: ASTM D434-1995; ASTM D4970/D4970M-2010c1, ASTM D3107-07(R2011), AATCC 127, and JIS L1099 Method B-1:2006. There is further provided a polyester fabric which is waterproof, breathable, stretchable in 4 directions, and insulating to −50 degrees Celsius.

### DETAILED DESCRIPTION OF THE INVENTION

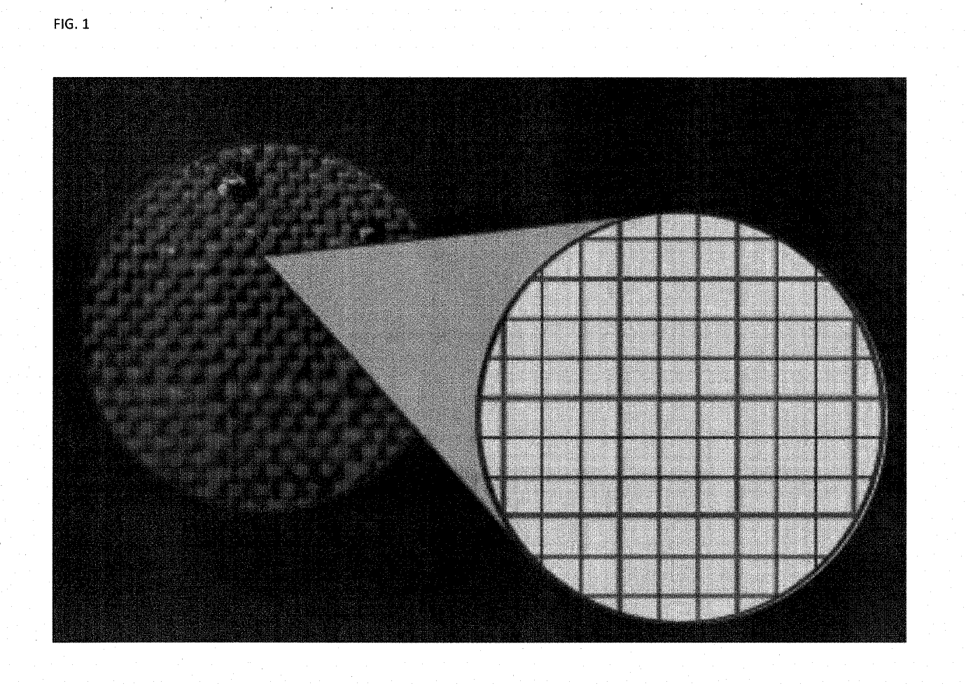

The fabric of the present invention is manufactured of polyester, nylon, or other thread materials in a trilobal construction. In this specification, “trilobal construction” is defined to be “the weaving together of three threads which are then inserted on the horizontal (weft) and vertical (warp) every 1 cm. The result is a checkerboard construction of repeating squares of thread as depicted in FIG. 1.

This construction increases the tensile strength of the fabric and reduces the incidence of tearing by incorporating the increased strength of three threads woven together into the core fabric. Early attempts to improve the polyester fabric comprised a stronger 600 Denier polyester fabric that has slightly lower tensile and tear resistance than a 420 Denier Nylon. Although this increase in Denier value resolves the strength and dye issue with the garments, the early versions of the product were heavy, stiff and inflexible, creating fatigue with the wearers.

To address this issue, the next fabrics developed incorporated trilobal construction, which is the weaving of three threads together and inserted into the woven fabrics every 1 cm in a checkerboard construction. The result of this new trilobal design was a garment in 300 Denier polyester with equal tensile, tear and puncture resistance as a non-trilobal 420 Denier Nylon. The garment was lighter and looser hanging, but still lacked any flexibility in the fabric.

The present invention further incorporates an elastane (Elastamor) filament within the woven threads that gives the fabric the ability to stretch 10% to 15% in all 4 directions. This technology has been used in the prior art with woven cottons, poly/cotton blends and other organic fibers, but these other materials would not stand up to the rigors of the industrial application of our market. Generally a fabric will stretch on its “bias” (the diagonal cross section of the woven fabric), but on the warp and weft polyester fibers are not flexible and have no stretch capacity. The present invention will stretch on the warp, weft, and both biases.

To meet the requirements of the industry, the fabric meets the critical tensile, tear, seam slippage and pilling resistance requirements of ASTM D2034-2009; ASTM D1424-2009: ASTM D434-1995; and ASTM D4970/D4970M-2010c1, and the fabric can stretch and recover, meeting the requirements of ASTM D3107-07(R2011). Prior art stretch fabrics can stretch out, but many have poor recovery resulting in bagging or sagging regions of the fabric around the buttocks, elbows and knees, unlike the present invention. The fabric also meets the AATCC 127 waterproof requirement of average 5000 (mmH2O) as well as the JIS L1099 Method B-1:2006 test with a minimum of 15,000 g/m2/24 hours.

The fabric of the invention further incorporates intertwining approximately 5% elastane into the fabric, and uses a laminate coating of PU instead of a spray coating.

The present invention comprises a novel fabric of stretchy woven polyester coated in a waterproof/breathable PU laminate. The invention uses trilobal construction with a laminated PU coating, as well as integrated Elastane to provide a fabric of greater strength than standard stretch fabrics, and more resistant to wear and washing than conventional stretch fabrics.

The present invention is a fully tested and functional waterproof and breathable, trilobal woven polyester industrial strength 4-way stretch fabric. In one embodiment, it may be manufactured into a coverall. Other items of clothing and other items requiring the features of stretch, durability, waterproofing, breathability and flexibility are also within the scope of the invention.

Fabric Testing Results

300D Fabric Tests

A fabric sample comprising Woven 300D fabric, 95% polyester 5% spandex, was tested for water resistance, water vapour permeability, water vapour transmission, tensile strength, tearing strength, seam slippage, pilling resistance, and stretch properties.

Tensile Strength (ASTM D5034-2009; Instron CRE—1″ Grab)

| | |
|---|---|
| Warp (lbf) | 214.0 |
| Weft (Ibf) | 212.0 |

Tearing Strength (ASTM D1424-2009; Elmendorf)

| | |
|---|---|
| Warp yarns torn (lbf) | >14.1 |
| Weft yarns torn (lbf) | >14.1 |

Seam Slippage (ASTM D434-1995; Instron CRE)

Seam Slippage at ¼ Inch

| | |
|---|---|
| Seam/Warp (lbf) | 53.1 (Sewing Thread Breaks (S.T.B.) |
| Seam/Weft (lbf) | 51.0 (S.T.B.) |

Pilling Resistance (ASTM D 49700 D4970M-201e1; Martindale Tester)

| After 100 movements Rating | | 4.5 |
|---|---|---|
| Remarks: Pilling Rating | 5 | No pilling |
| | 4 | Slight pilling |
| | 3 | Moderate pilling |
| | 2 | Severe pilling |
| | 1 | Very severe pilling |

Stretch Properties of Fabrics Woven from Stretch Yarns

(ASTM D3107-07(R2011)) Gauge Length=250 mm

| | Warp |
|---|---|
| A. Fabric stretch after applying a specified tension at 4 lb load | |
| (I) Within 10 s (%) | 13.2 |
| (II) After 30 min. (%) | 14.4 |
| B. Fabric growth after applying to specified tension and relaxation | |
| (I) Within 10 s (%) | 2.8 |
| (II) After 30 s (%) | 2.4 |
| C. Fabric growth after stretching to a specified extension of | |
| 280 mm and relaxation | |
| (I) After 30 s (%) | 2.0 |
| (II) After 30 min. (%) | 0.8 |
| The maximum allowable stretch requirement is 7%. | |
| D. Fabric recovery after stretching to a specified extension of | |
| 280 mm and relaxation | |
| (I) After 30 min. (%) | 93.3 |
| The minimum recovery requirement is 75%. | |

Stretch Properties of Fabrics Woven from Stretch Yarns

(ASTM D3107-07(R2011)) Gauge Length=250 mm

| | Weft |
|---|---|
| A. Fabric stretch after applying a specified tension at 4 lb load | |
| (I) Within 10 s (%) | 15.2 |
| (II) After 30 min. (%) | 17.2 |
| B. Fabric growth after applying to specified tension and relaxation | |
| (I) Within 10 s (%) | 4.0 |
| (II) After 30 s (%) | 3.2 |
| C. Fabric growth after stretching to a specified extension of | |
| 286 mm and relaxation | |
| (I) After 30 s (%) | 2.8 |
| (II) After 30 min. (%) | 1.2 |
| The maximum allowable stretch requirement is 7%. | |
| D. Fabric recovery after stretching to a specified extension of | |
| 286 mm and relaxation | |
| (I) After 30 min. (%) | 91.7 |
| The minimum recovery requirement is 75%. | |

Water Resistance: Hydrostatic Pressure Test

(AATCC 127-2008; Hydrostatic Head; Rate of Increase of Water Pressure: 60 cm H₂0/Min Temp. of Distilled Water: 20° C., Face Side Facing Water)

| | Specimen | | | |
|---|---|---|---|---|
| | #1 | 2# | 3# | Average After 5 washes |
| Water Column | 5161 | 4641 | 4457 | 4753 |
| (mmH₂0) | | | | |

Wash procedure (AATCC 135-2010; Test No. (1) IIIB; Machine wash at 105 degree F. with 4 lb loading, normal cycle & line dry).

Water Vapour Permeability of Textiles (J IS Li 099 Method B-1:2006)

Temperature of oven: 30° C.

Test Method: Potassium Acetate

Test Duration: 15 minutes.

Orientation: Back side Facing Water

After 5 washes

| | |
|---|---|
| (g/m²/hour) | 950 |
| (g/m²/24 hours) | 22800 |

Wash procedure (AATCC 135-2010; Test No. (1) IIIB; Machine wash at 105 degree F. with 4 lb loading, normal cycle & line dry).

Water Vapour Transmission of Textile Fabrics* (ASTM E96:1995)

Procedure BW—Inverted Water Method at 73.4° F. (23° C.) & 50±2% RH

Tested Area: 0.003117 square metre

Orientation: Back Facing Water

After 5 washes

Gram per square metre per 24 hours 8461

Wash procedure: (AATCC 135-2004; Test No. (1) IIIB; Machine wash at 105 degree F. with 41b total loading, normal cycle & line dry)

600D Fabric Tests

A fabric sample comprising Woven 600D*600D/78t polyester oxford four ways stitch+TPU film 5 k/5 k was tested for water resistance, water vapour permeability, water vapour transmission, strength, tearing strength, seam slippage, pilling resistance, and stretch properties.

Water Resistance: Hydrostatic Pressure Test

AATCC 135-2012: Test No. (2) JIB: machine wash at 85 degree F. with 41b loading, without detergent, gentle cycle & line dry

(AATCC 127-2008; Hydrostatic Head; Rate of increase of water pressure: 60 cm H₂O/min temp. of distilled water: 200 C, face side facing water)

| | Specimen | | | |
|---|---|---|---|---|
| | 1 | 2 | 3 | Average As Received |
| Water Column | 13444 | 13097 | 12985 | 13175 |
| (mmH₂0) | | | | |

After 5 washes

| | | | | |
|---|---|---|---|---|
| Water Column | 12913 | 12434 | 12597 | 12648 |
| (mmH₂0) | | | | |

Water Vapour Permeability of Textiles (JIS L1099 Method B-1:2006)

Temperature of oven: 30° C.

Test Method: Potassium Acetate

Test Duration: 15 min.

Orientation: Back side Facing Water

| | As Received | After 5 washes |
|---|---|---|
| (g/m²/hour) | 442 | 567 |
| (g/m²/24 hours) | 10608 | 13608 |

Water Vapour Transmission of Textile Fabrics* (ASTM E96:1995)

Procedure BW—Inverted Water Method at 73.4° F. (23° C.) & 50±2% RH Tested Area: 0.003117 square metre

Orientation: Back side Facing Water

| | As Received | After 5 washes |
|---|---|---|
| G/m² per 24 hours | 6736 | 6606 |

Washing procedure (AATCC 135-2012: Test No. (2) IIB: machine wash at 85 degree F. with 41b loading, without detergent, gentle cycle & line dry).

Tensile Strength (ASTM D5034-2009; Instron CRE-1″ Grab)

| | |
|---|---|
| Warp (lbf) | 291.8 |
| Weft (lbf) | 260.8 |

Tearing Strength (ASTM D1424-2009; Elmendorf Tear)

| | |
|---|---|
| Warp yarns torn (lbf) | >14.1 |
| Weft yarns torn (lbf) | >14.1 |

Seam Slippage (ASTM D434-1995)

| | |
|---|---|
| Seam Slippage at ¼ inch | #: Before ¼ inch opening |
| Seam/Warp (lbf) | 59.4# (S.T.B) |
| Seam/Weft (lbf) | 63.8# (S.T.B) |

Pilling Resistance (ASTM D4970/D4970M-10e1; Martindale Abrasion & Pilling Tester After 100 Cycles, Using Viewing Cabinet 45° Viewing Angle)

| | |
|---|---|
| After 100 revs | 4.0 |
| Pilling Rating | 5 No pilling |
| | 4 Slight pitting |
| | 3 Moderate pitting |
| | 2 Severe pitting |
| | 1 Very severe pitting |

Stretch Properties of Fabrics Woven from Stretch Yarns

(ASTM D3107-07(R201 1) Gauge Length=250 mm

| | | Warp |
|---|---|---|
| A. | Fabric stretch after applying a specified tension | |
| | at 4 lbf load | |
| | (I) Within 10 s (%) | 11.6 |
| | (II) After 30 min. (%) | 12.0 |
| B. | Fabric growth after applying to specified tension | |
| | and relaxation | |
| | (I) Within 10 s (%) | 2.0 |
| | (II) After 30 s (%) | 1.6 |
| C. | Fabric growth after stretching to a specified | |
| | extension of 276 mm and relaxation | |
| | (I) After 30 s (%) | 2.0 |
| | (II) After 30 min. (%) | 0.8 |
| D. | Fabric recovery after stretching to a specified | |
| | extension of 276 mm and relaxation | |
| | (I) After 30 min. (%) | 92.3 |

Stretch Properties of Fabrics Woven from Stretch Yarns (ASTM D3107-07(R2011) Gauge length=250 mm

| | | Weft |
|---|---|---|
| A. | Fabric stretch after applying a specified tension | |
| | at 4 lbf load | |
| | (I) Within 10 s (%) | 20.8 |
| | (II) After 30 min. (%) | 22.8 |
| B. | Fabric growth after applying to specified tension | |
| | and relaxation | |
| | (I) Within 10 s (%) | 4.8 |
| | (II) After 30 s (%) | 4.0 |
| C. | Fabric growth after stretching to a specified | |
| | extension of 276 mm and relaxation | |
| | (I) After 30 s (%) | 3.6 |
| | (II) After 30 min. (%) | 1.6 |
| D. | Fabric recovery after stretching to a specified | |
| | extension of 276 mm and relaxation | |
| | (I) After 30 min. (%) | 91.7 |

The coverall of the present invention is an extreme cold climate coverall. Typically such coveralls are made with heavy duty cotton fabrics, are insulated with poly-fill to a cold rating of −50 degrees C. In such prior art cold weather coveralls, the consumer cannot move in them as they are so restrictive to body movement due to the bulk of the garment. In contrast, the 4-way fabric of the present invention is a −50 degree C. insulated coverall that is waterproof, and breathable, with 250 GSM insulation. This coverall is also extremely flexible to provide almost no restriction to movement.

The present invention combines several known technologies, including trilobal weaving construction, laminated PU coatings for high level breathability, as well as waterproofing, and stretch fabric technology using elastane, to form a unique fabric.

As many possible embodiments may be made of the invention without departing from the scope of the claims, it is to be understood that all matter herein set forth or shown in the accompanying drawings is illustrative and not limiting. It will be appreciated by those skilled in the art that other variations of the preferred embodiment may also be practised without departing from the scope of the invention.

What is claimed is:

1. A woven polyester fabric wherein the fabric has a trilobal woven construction and a 5% elastane content.

2. The fabric of claim 1, further comprising an outer laminated layer of polyurethane.

3. The fabric of claim 2, wherein the fabric has 250 GSM insulation.

4. The fabric of claim 2, wherein the fabric meets the standards defined by the testing standards ASTM D2034-2009; ASTM D1424-2009: ASTM D434-1995; ASTM D4970/D4970M-2010c1, ASTM D3107-07(R2011), AATCC 127, and JIS L1099 Method B-1:2006.

5. A woven polyester fabric which has a trilobal woven construction and is laminated in polyurethane.

6. The fabric of claim 5, further comprising 5% elastane woven into the fabric.

7. The fabric of claim 6, wherein the fabric has 250 GSM insulation.

8. The fabric of claim 6, wherein the fabric meets the standards defined by the testing standards ASTM D2034-2009; ASTM D1424-2009: ASTM D434-1995; ASTM D4970/D4970M-2010c1, ASTM D3107-07(R2011), AATCC 127, and JIS L1099 Method B-1:2006.
